(19) United States
(12) Patent Application Publication
(10) Pub. No.: US 2013/0033397 A1
(43) Pub. Date: Feb. 7, 2013

(54) METHODS FOR RECEIVING GPS INDOORS WITH HIGH PRECISION AND DEVICES THEREOF

(71) Applicants: John Fischer, Corfu, NY (US); Gilles Boime, Orsay (FR); Denis Reilly, Victor, NY (US); Michael Sander, Pittsford, NY (US); David Sohn, Pittsford, NY (US)

(72) Inventors: John Fischer, Corfu, NY (US); Gilles Boime, Orsay (FR); Denis Reilly, Victor, NY (US); Michael Sander, Pittsford, NY (US); David Sohn, Pittsford, NY (US)

(73) Assignee: Spectracom Corporation, Rochester, NY (US)

(21) Appl. No.: 13/567,688

(22) Filed: Aug. 6, 2012

Related U.S. Application Data
(60) Provisional application No. 61/515,114, filed on Aug. 4, 2011.

(51) Int. Cl. G01S 19/48; G01S 19/05

(52) U.S. Cl. 342/357.31; 342/357.42

(57) ABSTRACT

A method, non-transitory computer readable medium, and apparatus that determines a GPS location includes obtaining assisted GPS data of locations of a plurality of GPS satellites, current time, and initial location data of the receiver computing device. A GPS signal from one or more of the plurality of GPS satellites within a frequency range and time range is acquired based on the obtained assisted GPS data, current time, and initial location data of the receiver computing device. The one or more acquired GPS signals are integrated over a frame period of two or more seconds. A GPS location for the receiver computing device is determined based on the one or more integrated GPS signals.

This application claims the benefit of U.S. Provisional Patent Application Ser. No. 61/515,114, filed Aug. 4, 2011, which is hereby incorporated by reference in its entirety.

### FIELD

This invention generally relates to a Global Positioning System (GPS) and methods thereof, more particularly, to methods for receiving GPS indoors with high precision and devices thereof.

### BACKGROUND

For many time and frequency server applications, the most difficult and costly aspect of the installation is locating the GPS antenna. In data centers, computer rooms, offices, equipment shelters, and other internal locations, there is seldom an easy way to run an RF cable to the outside world or even to the nearest window. In multi-story and multi-tenant buildings, these cables must run through multiple spaces and domains, requiring approvals and coordination with several different parties. As a result, the cost and installation time for this effort often dwarfs the cost of and benefit of the equipment being installed.

### SUMMARY

An exemplary method for determining a GPS location includes obtaining by a receiver computing device assisted GPS data of locations of a plurality of GPS satellites, current time, and initial location data of the receiver computing device. A GPS signal from one or more of the plurality of GPS satellites within a frequency range and time range is acquired by the receiver computing device based on the obtained assisted GPS data, current time, and initial location data of the receiver computing device. The one or more acquired GPS signals are integrated by the receiver computing device over a frame period of two or more seconds. A GPS location for the receiver computing device is determined by the receiver computing device based on the one or more integrated GPS signals.

An exemplary GPS receiver apparatus includes a receiver computing device coupled to an antenna and an external oscillator. The receiver computing device has a memory coupled to one or more processors which are configured to execute programmed instructions stored in the memory including obtaining assisted GPS data of locations of a plurality of GPS satellites, current time, and initial location data of the receiver computing device. A GPS signal from one or more of the plurality of GPS satellites within a frequency range and time range is acquired based on the obtained assisted GPS data, current time, and initial location data of the receiver computing device. The one or more acquired GPS signals are integrated over a frame period of two or more seconds. A GPS location for the receiver computing device is determined based on the one or more integrated GPS signals.

An exemplary non-transitory computer readable medium having stored thereon instructions for determining a GPS location comprising machine executable code which when executed by at least one processor, causes the processor to perform steps including obtaining assisted GPS data of locations of a plurality of GPS satellites, current time, and initial location data of the receiver computing device. A

GPS signal from one or more of the plurality of GPS satellites within a frequency range and time range is acquired based on the obtained assisted GPS data, current time, and initial location data of the receiver computing device. The one or more acquired GPS signals are integrated over a frame period of two or more seconds. A GPS location for the receiver computing device is determined based on the one or more integrated GPS signals.

This technology provides a number of advantages including providing more effective devices and methods for receiving a GPS signal indoors with high precision. With this technology, equipment with GPS capability can easily be installed inside offices and other dwellings without expensive, difficult and time consuming modifications or direct outdoor access.

### BRIEF DESCRIPTION OF THE DRAWINGS

FIG. 1 is a block diagram an exemplary indoor GPS receiver apparatus;

FIG. 2 is a block diagram another exemplary indoor GPS receiver apparatus; and

FIGS. 3A-3C are flowcharts of an exemplary method for determining a GPS location indoors with high precision.

### DETAILED DESCRIPTION

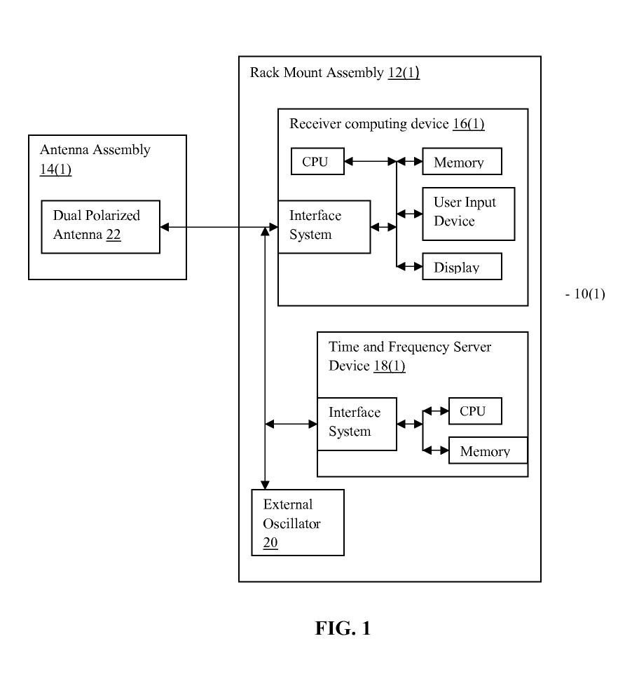

An exemplary indoor GPS receiving apparatus 10(1) is illustrated in FIG. 1. The exemplary indoor GPS receiving apparatus 10(1) includes a rack mount assembly 12(1) and an antenna assembly 14(1), although the apparatus could comprise other types of systems, device, components and/or elements in other configurations. This technology provides a number of advantages including providing effective devices and methods for receiving a GPS signal indoors with high precision.

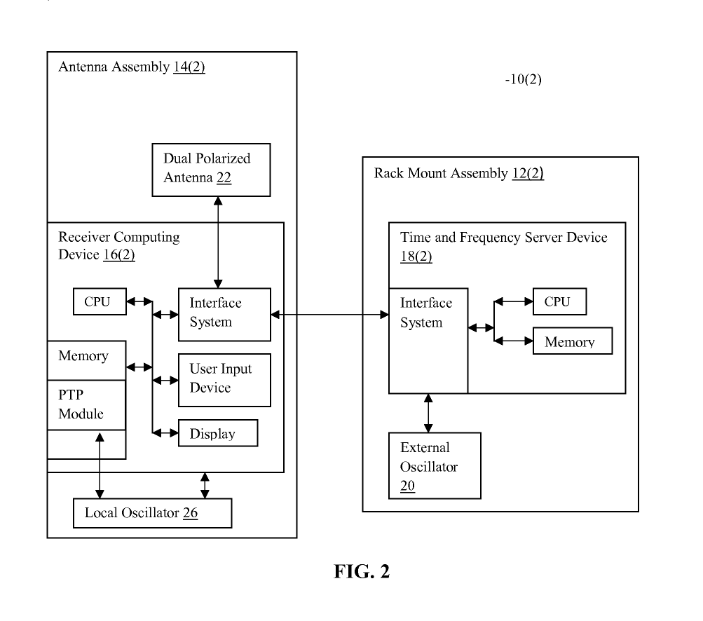

Referring more specifically to FIG. 1, the rack mount assembly 12(1) includes a GPS receiver computing device 16(1), a time and frequency server device 18(1), and an ultra-stable oscillator 20, although the rack mount assembly could comprise other types of systems, device, components and/or elements in other configurations, such as the rack mount assembly 12(2) illustrated in FIG. 2 by way of example only.

The GPS receiver computing device 16(1) includes a central processing unit (CPU) or processor, a memory, and an interface system which are coupled together by a bus or other link, although other numbers and types of components, parts, devices, systems, and elements in other configurations and locations can be used. The processor in the GPS receiver computing device 16(1) executes a program of stored instructions one or more aspects of the present invention as described and illustrated by way of the embodiments herein, although the processor could execute other numbers and types of programmed instructions.

The memory in the GPS receiver computing device 16(1) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor in the GPS receiver computing device 16(1), can be used for the memory in the GPS receiver computing device 16(1).

The interface system in the GPS receiver computing device 16(1) is used to operatively couple and communicate between the GPS receiver computing device 16(1) and the patch antenna unit 22, the ultra stable oscillator 20, and the time and frequency server 18(1) via hard wire connections and an Internet connection, although other types and numbers of communication networks with other types and numbers of connections, configurations, and protocols can be used. By way of example only, the communication networks can use TCP/IP over Ethernet and industry-standard protocols, including HTTP, HTTPS, WAP, and SOAP, although other types and numbers of communication networks, such as a direct connection, a local area network, a wide area network, modems and phone lines, e-mail, and wireless and hardwire communication technology, each having their own communications protocols, can be used.

The time and frequency server device 18(1) includes a central processing unit (CPU) or processor, a memory, and an interface system which are coupled together by a bus or other link, although other numbers and types of components, parts, devices, systems, and elements in other configurations and locations can be used. The processor in the time and frequency server device 18(1) executes a program of stored instructions one or more aspects of the present invention as described and illustrated by way of the embodiments herein, although the processor could execute other numbers and types of programmed instructions.

The memory in the time and frequency server device 18(1) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor in the time and frequency server device 18(1), can be used for the memory in the time and frequency server device 18(1).

The interface system in the time and frequency server device 18(1) is used to operatively couple and communicate between the time and frequency server device 18(1), the GPS receiver computing device 16(1) and the ultra stable oscillator 20, via an Internet connection and hard wire connections, although other types and numbers of communication networks with other types and numbers of connections, configurations, and protocols can be used. By way of example only, the communication networks can use TCP/IP over Ethernet and industry-standard protocols, including HTTP, HTTPS, WAP, and SOAP, although other types and numbers of communication networks, such as a direct connection, a local area network, a wide area network, modems and phone lines, e-mail, and wireless and hardwire communication technology, each having their own communications protocols, can be used.

The ultra stable oscillator 20 is an external oscillator that has a stability sufficient low enough so that the variations over the integration period, such as over two, ten, or hundreds of seconds or more as described in greater detail herein, is insignificant as compared to the signal modulation received from the visible GPS satellites, although other types of oscillators could be used. In this particular example, the ultra stable oscillator 20 is a high-performance OCXO™ oscillator or a Rubidium oscillator, although again other types of oscillators could be used.

The antenna assembly 14(1) includes a dual polarized antenna 22, although the antenna assembly 14(1) could comprise other types and numbers of antennas, systems, device, components and/or elements in other configurations, such as the antenna assembly 14(2) illustrated in FIG. 2 by way of example only. In this particular example, the patch antenna unit 22 is configured to capture multipath energy, e.g. Right Hand Circular Polarized (RHCP) and Left Hand Circular Polarized (LHCP) energy, for the GPS receiver computing device 16(1), although other types and numbers of antennas to capture other types of energy could be used, such as a just a Right Hand Circular Polarized (RHCP) antenna by way of example only. The dual polarized antenna 22 is connected to the GPS receiver computing device 16(1) via a CATS Ethernet cable and uses PoE (Power over Ethernet) for a power supply, although other types and numbers of connections could be used.

Referring to FIG. 2, another exemplary indoor GPS receiving apparatus 10(1) is illustrated. Elements in exemplary indoor GPS receiving apparatus 10(2) which are like those in exemplary indoor GPS receiving apparatus 10(1) will have like reference numerals and are the same in structure and operation, except as illustrated and described herein.

The rack mount assembly 12(1) includes a time and frequency server device 18(2), and an ultra-stable oscillator 20, although the rack mount assembly could comprise other types of systems, device, components and/or elements in other configurations. The time and frequency server device 18(2) is the same is structure and operation as the time and frequency server 18(1), except as illustrated and described herein. Additionally, the ultra-stable oscillator 20 in the exemplary indoor GPS receiving apparatus 10(1) is the same as the ultra-stable oscillator 20 in the exemplary indoor GPS receiving apparatus 10(2), except in the exemplary indoor GPS receiving apparatus 10(2) the ultra-stable oscillator 20 is not coupled to the receiver computing device 16(2), although other configurations could be used.

The antenna assembly 14(1) includes a receiver computing device 16(2), a dual polarized antenna 22, and a local external oscillator 26, although the antenna assembly 14(1) could comprise other types and numbers of antennas, systems, device, components and/or elements in other configurations. The receiver computing device 16(2) is the same in structure and operation as receiver computing device 16(1), except as illustrated and described herein. In particular, receiver computing device 16(2) includes a memory with a Precision Timing Protocol (PTP) module which comprises programmed instructions for transferring precision time synchronization across the interface between the receiver computing device 16(1) and other elements as illustrated and described herein, although the memory can contain other types and numbers of modules and other programmed instructions. Additionally, the dual polarized antenna 22 in the exemplary indoor GPS receiving apparatus 10(1) is the same as the dual polarized antenna 22 in the exemplary indoor GPS receiving apparatus 10(2), although other types and numbers of antennas could be used. Further, the local external oscillator 26 is coupled to receiver computing device 16(2) including the PTP module, although the local external oscillator 26 can be coupled to other types and numbers of systems, device, components and other elements. The local external oscillator 26 is used to drive the receiver computing device 16(2) and is phase locked to the rack mount ultra stable external oscillator 20, although this oscillator could have other types and numbers of functions and one or both oscillators could be located internally. To maintain a stable oscillator signal for the local external oscillator 26 Synchronous Ethernet (SyncE) packets are used to give a phase lock reference to the local external oscillator 26 from the ultra stable external oscillator 20 coupled to the time and frequency server device 18(2).

Although examples of the GPS receiver computing devices 16(1) and 16(2) the time and frequency server devices 18(1) and 18(2) are described and illustrated herein, each of the GPS receiver computing devices 16(1) and 16(2) the time and frequency server devices 18(1) and 18(2) can be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more computing systems or devices can be substituted for any one of the systems in any embodiment of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, 3G communications networks, Public Switched Telephone Network (PSTNs), Packet Data Networks (PDNs), the Internet, intranets, and combinations thereof.

The examples also may be embodied as non-transitory computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

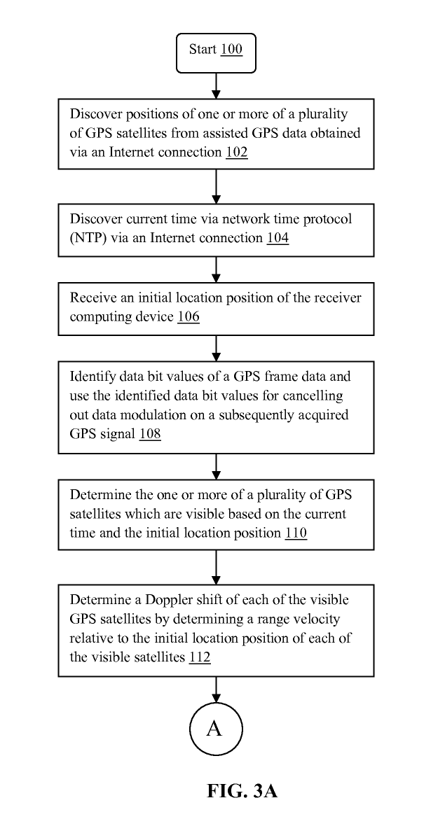

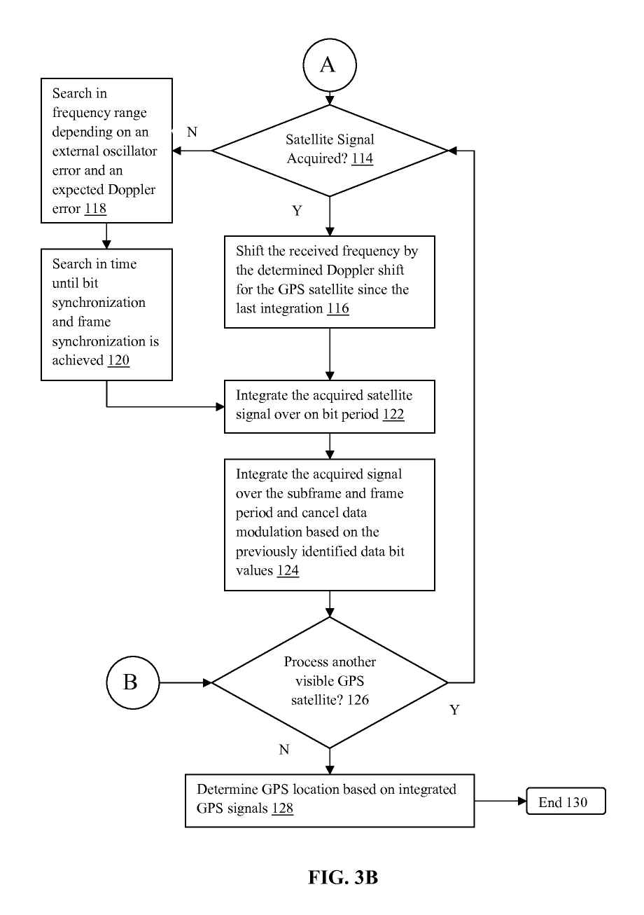

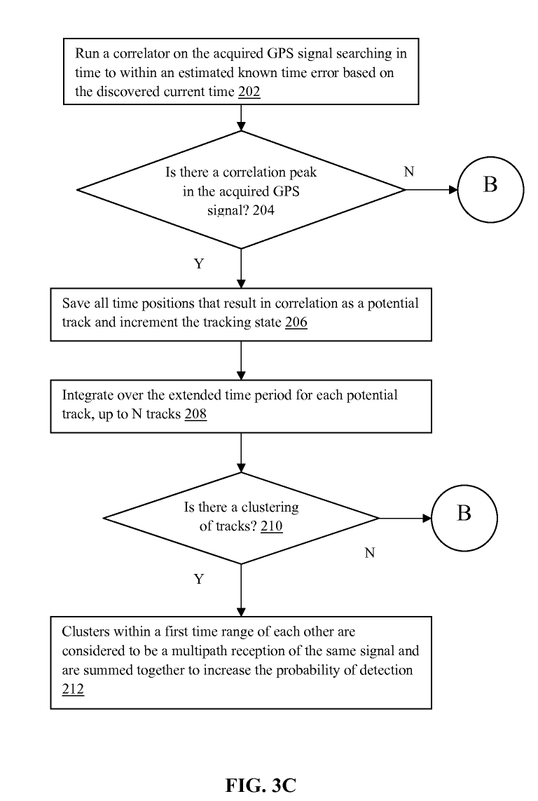

Referring to FIGS. 3A-3C, flowcharts of steps for an exemplary method for obtaining a GPS signal indoors with high precision using the exemplary indoor GPS receiving apparatus 10(1) are illustrated and described. The operation of the exemplary indoor GPS receiving apparatus 10(2) is the same, except as illustrated and described herein. Referring more specifically to FIGS. 3A-3C, the exemplary method for determining a GPS location indoors with high precision starts.

In step 102, the receiver computing device 16(1) obtains assisted GPS data from an Assisted GPS server device (not shown) via an Internet connection, although other manners for obtaining assisted GPS data about other numbers of GPS satellites can be used. As explained in greater detail herein, with the assisted GPS data the receiver computing device 16(1) can acquire weak GPS signals faster.

In step 104, the receiver computing device 16(1) determines the current time from the time and frequency server 18(1) to within about 100 milliseconds via network time protocol (NTP), although other manners for obtaining the current time within other timeframes and from other sources could be used.

In step 106, the receiver computing device 16(1) receives its own current location data based on operator entry with at least one km accuracy, although the current location data can be obtained in other manners, such as from a stored location entry in memory or from another location determination device, and with other degrees of accuracy.

In step 108, the receiver computing device 16(1) determines the data bit values of the GPS frame data from the assisted GPS data and then uses these determined data bit values to cancel out data modulation on acquired GPS signals, although other manners for cancelling out data and/or other modulations can be used.

In step 110, the receiver computing device 16(1) determines which of a plurality of GPS satellites is visible or otherwise within an acceptable frequency range and time range for the receiver computing device 16(1), although other manners for determining which of the plurality of GPS satellites are visible could be used. In this particular example, the receiver computing device 16(1) determines if one or more of the plurality of GPS satellites is visible based on the determined current time and the received current location data. When making this determination, the receiver computing device 16(1) does not use masking angles because acquisition of GPS signals from the one or more of the plurality of GPS satellites by multipath is desirable in this particular example and should not be filtered out, although other manners for making this determination can be used.

In step 112, the receiver computing device 16(1) determines the Doppler shift of each visible GPS satellite by determining a range velocity of each visible GPS satellite relative to the received current location data by the receiver computing device 16(1), although other manners for determining or otherwise compensating for Doppler shift could be used.

Referring to FIG. 3B, in step 114, the receiver computing device 16(1) determines whether a GPS satellite signal from one of visible GPS satellites has been acquired. If the receiver computing device 16(1) determines that the GPS satellite signal from one of the visible satellites has been acquired, then the Yes branch is taken to step 116.

In step 116, the receiver computing device 16(1) shifts the received frequency of the acquired GPS satellite signal by the previously determined Doppler shift for that visible GPS satellite determined in step 112 since the last integration, although other manners for adjusting the received frequency can be used. Since GPS satellites are continuously moving relative to the surface of the earth, the Doppler shift is changing over time. Rising GPS satellites have a positive Doppler shift, setting GPS satellites have a negative shift, and those near the zenith have near zero shift. If back in step 114, the receiver computing device 16(1) determines the GPS satellite signal from one of the visible plurality of GPS satellites has not been acquired, then the No branch is taken to step 118.

In step 118, the receiver computing device 16(1) searches in a frequency range based on a frequency error of the external oscillator 20 and an expected Doppler shift error, although the receiver computing device 16(1) can search in another frequency range based on other types and numbers of factors. In this particular example, the frequency search bins used by the receiver computing device 16(1) are quite small because the errors noted above will be small because of the use of the obtained current time from the network time protocol which is accurate to within 100 milliseconds, although other frequency search bins and other ranges of time accuracy can be used. Using narrow search bins allows for faster acquisition of the weak signal and reduces the probability of false detect. The Doppler frequency of the GPS satellite can be +/− thousands of Hertz, depending on where the GPS satellite is in the sky and whether it is rising or setting. Opening up the frequency search bin to this range also opens the bandwidth of the receiver computing device 16(1) to more noise. Knowing the relative position and motion of the GPS satellite allows the frequency search bin to be reduced to tens of Hertz by the receiver computing device 16(1), reducing the noise bandwidth, the probability of false detection, and the acquisition time.

In step 120, the receiver computing device 16(1) searches in time until bit synchronization and frame synchronization is achieved. An exemplary method for searching in time until a bit synchronization and a frame synchronization is achieved is illustrated and described with reference to steps 302-314 in FIG. 3C.

In step 202, the receiver computing device 16(1) runs a pseudo noise (PN) correlator on signals received on each of the RHCP and LHCP antenna inputs of the dual polarized antenna 22 searching in time within a stored estimated known time error based on the current time received back in step 104, although other types of correlators and fewer or more antenna inputs could be used. The correlator operates on the received spread spectrum signals from the dual polarized antenna 22 to “de-spread” or integrate the signal spread over the frequency domain back into the original signal where the signal power is greater than the noise. This is a well known technique to those of ordinary skill in the art used by all spread spectrum receivers.

In step 204, the receiver computing device 16(1) determines if there is a correlation peak in the signals received on each of the RHCP and LHCP antenna inputs of the dual polarized antenna 22. If in step 204, the receiver computing device 16(1) determines there is not a correlation peak, then a No branch is taken to step 126 described below. If in step 204, the receiver computing device 16(1) determines there is a correlation peak in the received signal, then a Yes branch is taken to step 206

In step 206, the receiver computing device 16(1) saves all of the time positions that results in the determined correlation peak in step 204 as a potential track and increments the tracking state. A track is a time position measurement of the signal from one of the GPS satellites received by each of the RHCP and LHCP antenna inputs of the dual polarized antenna 22 that results in a pseudorange determination of the distance of the GPS satellite from the position of the receiver computing device 16(1). Because of the weak signal strength in the presence of noise, each of these tracks may be a false indication, as there is a small, but finite probability that noise could appear as a signal track. The tracking state is an indication of the quality of the track, i.e. no tracks yet, a single track, multiple tracks, etc, indicating a higher assurance that this track is not noise.

In step 208, the receiver computing device 16(1) integrates over an extended time period, such as two or more seconds by way of example only, for each potential track up to N tracks, although other extended time periods can be used, such as over ten seconds or over 100 seconds by way of example only. For each additional track that aligns in time from this integration process executed by the receiver computing device 16(1), the probability of the position being a false detection decreases. After N tracks aligning, the assurance is high enough for the receiver computing device 16(1) to declare this time measurement as the true position, although other manners for managing the tracks to confirm a received GPS signal can be used. The number of potential tracks which are examined in this step is set in memory in the receiver computing device 16(1), although the number of potential tracks can be obtained in other manners, such as by operator input, and typically is based on the size of the memory in the receiver computing device 16(1).

In step 210, the receiver computing device 16(1) determines if there is a clustering of the integrated tracks. In this particular example, integrated tracks that are within 100 nanoseconds of each other are determined by the receiver computing device 16(1) to be multipath reception of the same signal and thus a cluster, although other time ranges and other manners for identifying clusters of tracks can be used. If in step 210, the receiver computing device 16(1) determines there is not a clustering of the integrated tracks, then the No branch is taken to step 126. If in step 210, the receiver computing device 16(1) determines there is a clustering of two or more of the integrated tracks, then the Yes branch is taken to step 212.

In step 212, the receiver computing device 16(1) sums together the identified clusters of two or more of the integrated tracks to obtain the acquired GPS signal from one of the GPS satellites, although other types of processing on the identified clusters of two or more of the integrated tracks could be used to acquire the GPS signal. Accordingly, this illustrates an example of improving the ability to acquire a GPS signal indoors.

Referring back to FIG. 3A, in step 122 the receiver computing device 16(1) integrates the acquired GPS signal over one period, such as a period of 20 milliseconds by way of example only. This integration of the acquired GPS signal is standard procedure in all GPS receivers as is well known to those of ordinary skill in the art.

In step 124, the receiver computing device 16(1) integrates the acquired GPS signal over a subframe period and frame period, such as six seconds and thirty seconds by way of example only, although other subframe periods and frame periods could be used. Frames and subframes are blocks of the GPS data that is superimposed on the ranging signal. Since this data stream is being obtained from the assisted GPS data via the internet connection, the data is already known and does not need to be decoded from the acquired GPS signal. Moreover, since this data is known, signals that align on these frame and subframe boundaries can be integrated together, increasing the signal power of this weak GPS signal. Additionally, the receiver computing device 16(1) removes the data bit modulation on the acquired GPS signal based on the previously learned data bit values from the assisted GPS data back in step 108, although other manners for removing the data bit modulation from the acquired GPS signals can be used. This removal of data bit modulation allows for integration times greater than one bit value (in this particular example milliseconds, although other time ranges could be used) by the receiver computing device 16(1).

In step 126, the receiver computing device 16(1) determines if this process should be repeated for another visible GPS satellite. If the receiver computing device 16(1) determines this process should be repeated for another visible

GPS satellite, then the Yes branch is taken back to step 116 as described earlier. If the receiver computing device 16(1) determines this process should not be repeated, then the No branch is taken to step 128.

In step 128, the receiver computing device 16(1) determines the GPS location of the receiver computing device 16(1) based on the integrated GPS signals as described in greater detail in the steps above. Since the manner for determining a location from obtained GPS signals is well known to those of ordinary skill in the art it will not be described here. In step 130, this exemplary method ends.

Another exemplary method for obtaining a GPS signal indoors with high precision using the exemplary indoor GPS receiving apparatus 10(2) is the same as illustrated and described above with reference to FIGS. 3A-3C, except that a local external oscillator 26 is used which is synchronized with the ultra stable external oscillator 20. The use of this local external oscillator 26 allows the receiver computing device 16(2) to be located closer to the antenna 22, eliminating the need for a low loss RF cable between the antenna assembly 14(2) and the rack mount assembly 12(2).

Accordingly, as illustrated by the examples illustrated and described herein this technology provides effective devices and methods for receiving a GPS signal indoors with high precisions. With this technology, equipment with GPS capability can be easily installed inside offices and other dwellings without expensive, difficult and time consuming installations and modifications while maintaining the GPS capability.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for determining a GPS location, the method comprising:
obtaining by a receiver computing device assisted GPS data of locations of a plurality of GPS satellites, current time, and initial location data of the receiver computing device;
acquiring by the receiver computing device a GPS signal from one or more of the plurality of GPS satellites within a frequency range and time range based on the obtained assisted GPS data, current time, and initial location data of the receiver computing device;
integrating by the receiver computing device the one or more acquired GPS signals over a frame period of two or more seconds; and
determining by the receiver computing device a GPS location for the receiver computing device based on the one or more integrated GPS signals.

2. The method as set forth in claim 1 wherein the obtaining further comprises obtaining by the receiver computing device the current time via network time protocol (NTP) over an Internet connection.

3. The method as set forth in claim 1 wherein the acquiring the GPS signal from the one or more of the plurality of GPS satellites further comprises obtaining from a dual polarized antenna coupled to the receiver computing device the GPS signal from the one or more of the plurality of GPS satellites.

4. The method as set forth in claim 1 wherein the integrating further comprises removing by the receiver computing device data modulation from the one or more acquired GPS signals.

5. The method as set forth in claim 4 wherein the removing the data modulation further comprises:
identifying by the receiver computing device data bit values from the assisted GPS data with the receiver computing device; and
eliminating by the receiver computing device the data modulation from the one or more acquired GPS signals based on the identified data bit values.

6. The method as set forth in claim 1 further comprising determining by the receiver computing device which one or more of the plurality of satellites are within the frequency range and the time range based on the obtained current time and the obtained initial location data of the receiver computing device, wherein the acquiring is further based on the determined one or more of the plurality of satellites which are within the frequency range and the time range.

7. The method as set forth in claim 1 further comprising determining by the receiver computing device a Doppler shift for a GPS signal from each of the one or more of the plurality of satellites.

8. The method as set forth in claim 7 wherein the acquiring the GPS signal from the one or more of the plurality of satellites further comprises shifting the frequency range by the determined Doppler shift to acquire the GPS signal from the one or more of the plurality of satellites.

9. The method as set forth in claim 8 wherein the determining the Doppler shift further comprises determining by the receiver computing device a range velocity of the one or more of the plurality of satellites relative to the obtained initial location data.

10. The method as set forth in claim 7 wherein the acquiring further comprises searching by the receiver computing device in another frequency range based on a frequency of an external oscillator coupled to the receiver computing device and a Doppler error based on the determined Doppler shift to acquire the GPS signal from the one or more of the plurality of GPS satellites.

11. A GPS receiver apparatus, the apparatus comprising:
a receiver computing device coupled to an antenna and an external oscillator, wherein the receiver computing device further comprises a memory coupled to one or more processors which are configured to execute programmed instructions stored in the memory comprising:
obtaining assisted GPS data of locations of a plurality of GPS satellites, current time, and initial location data of the receiver computing device;
acquiring a GPS signal from one or more of the plurality of GPS satellites within a frequency range and time range based on the obtained assisted GPS data, current time, and initial location data of the receiver computing device;
integrating the one or more acquired GPS signals over a frame period of two or more seconds; and
determining a GPS location for the receiver computing device based on the one or more integrated GPS signals.

12. The apparatus as set forth in claim 11 wherein the one or more processors is further configured to execute programmed instructions stored in the memory for the obtaining further comprising obtaining the current time via network time protocol (NTP) over an Internet connection.

13. The apparatus as set forth in claim 11 wherein the one or more processors is further configured to execute programmed instructions stored in the memory for the acquiring the GPS signal from the one or more of the plurality of GPS satellites further comprises obtaining from a dual polarized antenna coupled to the receiver computing device the GPS signal from the one or more of the plurality of GPS satellites.

14. The apparatus as set forth in claim 11 wherein the one or more processors is further configured to execute programmed instructions stored in the memory for the integrating further comprising removing data modulation from the one or more acquired GPS signals

15. The apparatus as set forth in claim 14 wherein the one or more processors is further configured to execute programmed instructions stored in the memory for the removing the data modulation further comprises:
identifying data bit values from the assisted GPS data; and
eliminating the data modulation from the one or more acquired GPS signals based on the identified data bit values.

16. The apparatus as set forth in claim 11 wherein the one or more processors is further configured to execute programmed instructions stored in the memory further comprising determining which one or more of the plurality of satellites are within the frequency range and the time range based on the obtained current time and the obtained initial location data of the receiver computing device, wherein the acquiring is further based on the determined one or more of the plurality of satellites which are within the frequency range and the time range.

17. The apparatus as set forth in claim 11 wherein the one or more processors is further configured to execute programmed instructions stored in the memory for the further comprising determining a Doppler shift for a GPS signal from each of the one or more of the plurality of satellites.

18. The apparatus as set forth in claim 17 wherein the one or more processors is further configured to execute programmed instructions stored in the memory for the acquiring the GPS signal from the one or more of the plurality of satellites further comprises shifting the frequency range by the determined Doppler shift to acquire the GPS signal from the one or more of the plurality of satellites.

19. The apparatus as set forth in claim 18 wherein the one or more processors is further configured to execute programmed instructions stored in the memory for the determining the Doppler shift further comprises determining a range velocity of the one or more of the plurality of satellites relative to the obtained initial location data.

20. The apparatus as set forth in claim 17 wherein the one or more processors is further configured to execute programmed instructions stored in the memory for the acquiring further comprises searching in another frequency range based on a frequency of an external oscillator coupled to the receiver computing device and a Doppler error based on the determined Doppler shift to acquire the GPS signal from the one or more of the plurality of GPS satellites.

21. A non-transitory computer readable medium having stored thereon instructions for determining a GPS location comprising machine executable code which when executed by at least one processor, causes the processor to perform steps comprising:
obtaining assisted GPS data of locations of a plurality of GPS satellites, current time, and initial location data of the receiver computing device;
acquiring a GPS signal from one or more of the plurality of GPS satellites within a frequency range and time range based on the obtained assisted GPS data, current time, and initial location data of the receiver computing device;
integrating the one or more acquired GPS signals over a frame period of two or more seconds; and
determining a GPS location for the receiver computing device based on the one or more integrated GPS signals.

22. The medium as set forth in claim 21 wherein obtaining further comprises obtaining the current time via network time protocol (NTP) over an Internet connection.

23. The medium as set forth in claim 21 wherein the acquiring the GPS signal from the one or more of the plurality of GPS satellites further comprises obtaining from a dual polarized antenna coupled to the receiver computing device the GPS signal from the one or more of the plurality of GPS satellites.

24. The medium as set forth in claim 21 further comprising removing data modulation from the one or more acquired GPS signals 20

25. The medium as set forth in claim 24 wherein the removing the data modulation further comprises:
identifying data bit values from the assisted GPS data; and
eliminating the data modulation from the one or more acquired GPS signals based on the identified data bit values.

26. The medium as set forth in claim 11 further comprising determining which one or more of the plurality of satellites are within the frequency range and the time range based on the obtained current time and the obtained initial location data of the receiver computing device, wherein the acquiring is further based on the determined one or more of the plurality of satellites which are within the frequency range and the time range.

27. The medium as set forth in claim 21 further comprising determining a Doppler shift for a GPS signal from each of the one or more of the plurality of satellites.

28. The medium as set forth in claim 27 wherein the acquiring the GPS signal from the one or more of the plurality of satellites further comprises shifting the frequency range by the determined Doppler shift to acquire the GPS signal from the one or more of the plurality of satellites.

29. The medium as set forth in claim 28 wherein the determining the Doppler shift further comprises determining a range velocity of the one or more of the plurality of satellites relative to the obtained initial location data.

30. The medium as set forth in claim 27 wherein the one or more processors is further configured to execute programmed instructions stored in the memory for the acquiring further comprises searching in another frequency range based on a frequency of an external oscillator coupled to the receiver computing device and a Doppler error based on the determined Doppler shift to acquire the GPS signal from the one or more of the plurality of GPS satellites.
